(19) United States
(12) Patent Application Publication
(10) Pub. No.: US 2026/0025627 A1
(43) Pub. Date: Jan. 22, 2026

(54) METHOD FOR PERSONALIZING A SOUND PROCESSING OF A HEARING DEVICE, A CORRESPONDING HEARING DEVICE AND A SYSTEM

(71) Applicant: GN Hearing A/S, Ballerup (DK)

(72) Inventor: Rob Anton Jurjen DE VRIES, Tilburg (NL)

(73) Assignee: GN Hearing A/S, Ballerup (DK)

(21) Appl. No.: 19/209,171

(22) Filed: May 15, 2025

(30) Foreign Application Priority Data
Jul. 18, 2024 (EP) 24189436.9

(51) Int. Cl. H04R 25/00; H04R 3/04

(52) U.S. Cl. CPC H04R 25/70; H04R 3/04

(57) ABSTRACT

Disclosed is a method at a system comprising a hearing device comprising a first acoustic input transducer and one or more second acoustic input transducers. The method comprises the steps of receiving by the first and the one or more second acoustic input transducers a configuration sound signal originating from a direction, providing from the first acoustic input transducer an in-the-ear received signal and from the one or more second acoustic input transducers a behind-the-ear received signal, determining filter values of a hearing device personalized configuration filter and compensating, by the hearing device, for reduced spectral pinna cues of sound signals received by the one or more second acoustic input transducers, thereby personalizing a sound processing of the hearing device.

### RELATED APPLICATION DATA

This application claims priority to, and the benefit of, European Patent Application No. 24189436.9 filed on Jul. 18, 2024, pending. The entire disclosure of the above application is expressly incorporated by reference herein.

### FIELD

The present disclosure relates to a method for personalizing a sound processing of a hearing device, a corresponding hearing device and a system comprising a hearing device adapted to execute such a method.

### BACKGROUND

People with normal hearing get cues for the sound source localization from a shaping of the incoming sound wave caused by the outer ear, the pinna.

Hearing impaired individuals using behind-the-ear (BTE) hearing devices do not get these important spatial cues, because the microphones of such hearing devices are placed outside the ear and, therefore, receive the sound wave before it is naturally shaped by the pinna.

Other types of hearing devices combine one or two BTE microphones with a microphone and receiver in the ear (M&RIE). In that case, the microphone in the ear (MIE) is used as much as possible in order to obtain a combined received sound signal at the hearing device as close to the one caused by the natural shaping of the sound wave by the pinna.

However, the use of the MIE is limited by technical issues, such as individual feedback margin and the amount of needed gain by the user of the hearing device to compensate his or her hearing loss. Thus, when feedback issues appear over a certain frequency range, the signal(s) from the BTE microphone(s) will be dominating.

It is known to use so-called pinna restoration patterns (or filters) for shaping the received sound signal(s) from the BTE microphone(s) in a way corresponding to the natural pinna shaping of the incoming sound wave. Such pinna restoration patterns, however, are generic and result in a restoration of the sound signals corresponding to an “average” pinna and not to the user's own pinna. Thus, in frequency regions where such pinna restoration patterns are used on the signal(s) from the BTE microphone(s), the user of the hearing device experiences a degraded localization and externalization performance.

Thus, there is a need for an improved method and a corresponding system that addresses the abovementioned challenges.

### SUMMARY

It is an object of the present disclosure to provide a method, a hearing device and a system, which overcome the above-mentioned disadvantages of the present solutions within this field of art.

According to a first aspect, disclosed is a method at a system comprising a hearing device configured to be worn by a user. The hearing device comprises a first acoustic input transducer arranged in-the-ear and one or more second acoustic input transducers arranged behind-the-ear. The method comprises the step of receiving by the first acoustic input transducer and the one or more second acoustic input transducers a configuration sound signal. The configuration sound signal originates from a direction relative to the hearing device. The method further comprises the step of providing from the first acoustic input transducer an in-the-ear received signal based on the configuration sound signal and the step of providing from the one or more second acoustic input transducers a behind-the-ear received signal based on the configuration signal. The method further comprises the step of determining filter values of a hearing device personalized configuration filter. The filter values of the hearing device personalized configuration filter are determined based on the in-the-ear frequency response signal and the behind-the-ear frequency response signal. The method further comprises the step of compensating, by the hearing device and when the hearing device is in use, for reduced spectral pinna cues of sound signals received by the one or more second acoustic input transducers, compared to the sound signals received by the first acoustic input transducer, based on the determined filter values of the hearing device personalized configuration filter, thereby personalizing a sound processing of the hearing device.

The first acoustic input transducer is configured to be arranged in-the-ear of the user. Thus, sound received by the first acoustic input transducer are naturally shaped by the outer ear, the pinna, giving monaural spectral cues or spectral pinna cues used for sound source localisation and externalisation. The one or more second acoustic input transducers are configured to be arranged behind-the-ear. Thus, the sound received by the one or more second acoustic input transducers are not naturally shaped by the outer ear of the user. Hence, the sound received by the one or more acoustic input transducers comprises reduced or less monaural spectral cues/spectral pinna cues, compared to signals sound signals received by the first acoustic input transducer.

It is an advantage that the method allows for personalizing/individualizing the sound processing/listening profile of the hearing device for each individual user for at least said direction. Thus, the method allows for compensating for reduced spectral pinna cues of sound signals received by the one or more second acoustic input transducers, compared to the sound signals received by the first acoustic input transducer. This in turn allows for correcting, or at least improving the localisation and externalisation of the received sound, making an overall sound experience natural, or at least more natural, for each individual user. The method further allows for personalizing the sound processing of the hearing device in a simple, accurate, flexible and user-friendly manner. The method allows for so-called “fine-tuning” of the hearing device. The fine-tuning can be performed by the user at any places such as the user's home. The fine-tuning can be performed by an audiologist or a hearing aid specialist at e.g. an audiology clinic.

The step of receiving, by the first acoustic input transducer and the one or more second acoustic input transducers, the configuration sound signal facilitates the personalizing of the sound processing of the hearing device in a simple manner. The configuration sound signal may originate from the direction relative to the ear of the user, when the user is wearing the hearing device at its intended position. By the direction is hereby meant a direction or an angle relative to the hearing device or relative to the ear of the user, when the user is wearing the hearing device at its intended position. The direction may be measured in azimuth and/or elevation. The first acoustic input transducer may be a MIE microphone. The one or more second acoustic input transducers may each be a BTE microphone.

The step of providing from the first acoustic input transducer, the in-the-ear received signal based on the configuration sound signal and the step of providing from the one or more second acoustic input transducers the behind-the-ear received signal based on the configuration signal allows for the first acoustic input transducer and the one or more second acoustic input transducers to capture the same configuration sound signal.

The step of providing the in-the-ear received signal and the behind-the-ear received signal based on the configuration signal facilitates the personalizing of the sound processing of the hearing device in an accurate manner, as it allows to identify differences in capturing of the configuration sound signal between/among the first acoustic input transducer and the one or more second acoustic input transducers. The first acoustic input transducer and the one or more second acoustic input transducers may capture the same configuration sound signal at the same time. The first acoustic input transducer and the one or more second acoustic input transducers may capture the same configuration sound signal approximately at the same time. There may be a slight time delay between the first acoustic input transducer capturing the configuration sound signal and the one or more second acoustic input transducers capturing the configuration sound signal. The slight time delay may be related to an arrangement of the first acoustic input transducer and the one or more second acoustic input transducers. For instance, in the case that the first acoustic input transducer is a MIE microphone and the one or more second acoustic input transducers is/are a BTE microphone, one of the MIE or BTE microphones may be arranged closer to the configuration sound signal.

The step of determining filter values of the hearing device personalized configuration filter, based on the in-the-ear received signal and the behind-the-ear received signal, facilitates the personalizing of the sound processing of the hearing device in an accurate manner. The hearing device personalized configuration filter may be an equalization filter. The hearing device personalized configuration filter may be a delay. The hearing device personalized configuration filter may comprise a Finite Impulse Response (FIR) filter or an Infinite Impulse Response (IIR) filter. The hearing device personalized configuration filter may be arranged at the hearing device i.e. the hearing device may comprise the hearing device personalized configuration filter.

The step of compensating, by the hearing device and when the hearing device is in use, for reduced spectral pinna cues of sound signals received by the one or more second acoustic input transducers, compared to the sound signals received by the first acoustic input transducer, based on the determined filter values of the hearing device personalized configuration filter allows for personalizing the sound processing of the hearing device. The step of compensating may comprise comparing the behind-the-ear received signal with the in-the-ear received signal. The step of compensating may comprise analyzing and/or identifying differences between the behind-the-ear received signal and the in-the-ear received signal. The step of compensating may comprise compensating for the identified differences of the behind-the-ear received signal with respect to the in-the-ear received signal. The step of compensating may comprise equalizing the behind-the-ear received signal with the in-the-ear received signal.

By the term “when the hearing device is in use” or “when in use”, it is hereby meant that the hearing device is worn by the user at its intended position and is on i.e. the user is using the hearing device.

In an embodiment, a hearing device is configured to be worn by a user. The hearing device may be arranged at the user's ear, on the user's ear, in the user's ear, behind the user's ear and/or in the user's concha, i.e., the hearing device is configured to be worn in, on and/or at the user's ear. The user may wear two hearing devices, one hearing device at each ear. The two hearing devices may be connected, such as wirelessly connected and/or connected by wires, such as a binaural hearing aid system.

The hearing device may be a hearable such as an earphone, hearing aid, a personal sound amplification product (PSAP), an over-the-counter (OTC) hearing device, a hearing protection device, a one-size-fits-all hearing device, or another head-wearable hearing device. Hearing devices can include both prescription devices and non-prescription devices.

The hearing device may be embodied in various housing styles or form factors comprising Behind-the-Ear (BTE) hearing device, Receiver-in-Canal (RIC) hearing device, Receiver-in-Ear (RIE) hearing device or Microphone-and-Receiver-in-Ear (MaRIE) hearing device. These devices may comprise a BTE unit configured to be worn behind the ear of the user and an in the ear (ITE) unit configured to be inserted partly into the user's ear canal or placed in the concha. Generally, the BTE unit may comprise at least one input transducers such as two microphones, a power source and a processing unit. The term BTE hearing device refers to a hearing device where the receiver, i.e. the output transducer, is comprised in the BTE unit and sound is guided to the ITE unit via a sound tube connecting the BTE and ITE units, whereas the terms RIE, RIC and MaRIE hearing devices refer to hearing devices where the receiver may be comprise in the ITE unit, which is coupled to the BTE unit via a connector cable or wire configured for transferring electric signals between the BTE and ITE units.

The ITE unit may comprise at least one Input transducer such as a microphone. The ITE unit may be configured to be inserted partly into the user's ear canal. The ITE unit may be custom made, meaning that the ITE unit may comprise a housing having a shell made from a hard material, such as a hard polymer or metal, or a soft material such as a rubber-like polymer, molded to have an outer shape conforming to the shape of the specific user's ear canal. The ITE unit may alternatively comprise an earpiece

The person skilled in the art is well aware of different kinds of hearing devices and of different options for arranging the hearing device in, on and/or at the ear of the hearing device wearer. The hearing device (or pair of hearing devices) may be custom fitted, standard fitted, open fitted and/or occlusive fitted.

In an embodiment, the hearing device may comprise a plurality of input transducers. The plurality of input transducers may comprise a plurality of microphones. The plurality of input transducers may comprise a plurality of vibration sensors configured for detecting bone vibration. The plurality of input transducer(s) may be configured for converting an acoustic signal into a plurality of electric input signal. The first electric input signal may be an analogue signal. The first electric input signal may be a digital signal. The plurality of input transducer(s) may be coupled to one or more analogue-to-digital converter(s) configured for converting the analogue first input signal into a digital first input signal.

In an embodiment, the hearing device may comprise one or more antenna(s) configured for wireless communication. The one or more antenna(s) may comprise an electric antenna. The electric antenna may be configured for wireless communication at a first frequency. The first frequency may be above 800 MHz, preferably a wavelength between 900 MHz and 6 GHz. The first frequency may be 902 MHz to 928 MHz. The first frequency may be 2.4 to 2.5 GHz. The first frequency may be 5.725 GHz to 5.875 GHz. The one or more antenna(s) may comprise a magnetic antenna. The magnetic antenna may comprise a magnetic core. The magnetic antenna may comprise a coil. The coil may be coiled around the magnetic core. The magnetic antenna may be configured for wireless communication at a second frequency. The second frequency may be below 100 MHz. The second frequency may be between 9 MHz and 15 MHz.

In an embodiment, the hearing device may comprise one or more wireless communication unit(s). The one or more wireless communication unit(s) may comprise one or more wireless receiver(s), one or more wireless transmitter(s), one or more transmitter-receiver pair(s) and/or one or more transceiver(s). At least one of the one or more wireless communication unit(s) may be coupled to the one or more antenna(s). The wireless communication unit may be configured for converting a wireless signal received by at least one of the one or more antenna(s) into a second electric input signal. The hearing device may be configured for wired/wireless audio communication, e.g. enabling the user to listen to media, such as music or radio and/or enabling the user to perform phone calls.

In an embodiment, the wireless signal may originate from one or more external source(s) and/or external devices, such as spouse microphone device(s), wireless audio transmitter(s), smart computer(s) and/or distributed microphone array(s) associated with a wireless transmitter. The wireless input signal(s) may origin from another hearing device, e.g., as part of a binaural hearing system and/or from one or more accessory device(s), such as a smartphone and/or a smart watch.

In an embodiment, the hearing device may include a processing unit. The processing unit may be configured for processing the first and/or second electric input signal(s). The processing may comprise compensating for a hearing loss of the user, i.e., apply frequency dependent gain to input signals in accordance with the user's frequency dependent hearing impairment. The processing may comprise performing feedback cancelation, beamforming, tinnitus reduction/masking, noise reduction, noise cancellation, speech recognition, bass adjustment, treble adjustment and/or processing of user input. The processing unit may be a processor, an integrated circuit, an application, functional module, etc. The processing unit may be implemented in a signal-processing chip or a printed circuit board (PCB). The processing unit may be configured to provide a first electric output signal based on the processing of the first and/or second electric input signal(s). The processing unit may be configured to provide a second electric output signal. The second electric output signal may be based on the processing of the first and/or second electric input signal(s).

In an embodiment, the hearing device may comprise an output transducer. The output transducer may be coupled to the processing unit. The output transducer may be a receiver. It is noted that in this context, a receiver may be a loudspeaker, whereas a wireless receiver may be a device configured for processing a wireless signal. The receiver may be configured for converting the first electric output signal into an acoustic output signal. The output transducer may be coupled to the processing unit via the magnetic antenna. The output transducer may be comprised in an ITE unit or in an earpiece, e.g. Receiver-in-Ear (RIE) unit or Microphone-and-Receiver-in-Ear (MaRIE) unit, of the hearing device. One or more of the input transducer(s) may be comprised in an ITE unit or in an earpiece.

In an embodiment, the wireless communication unit may be configured for converting the second electric output signal into a wireless output signal. The wireless output signal may comprise synchronization data. The wireless communication unit may be configured for transmitting the wireless output signal via at least one of the one or more antennas.

In an embodiment, the hearing device may comprise a digital-to-analogue converter configured to convert the first electric output signal, the second electric output signal and/or the wireless output signal into an analogue signal.

In an embodiment, the hearing device may comprise a vent. A vent is a physical passageway such as a canal or tube primarily placed to offer pressure equalization across a housing placed in the ear such as an ITE hearing device, an ITE unit of a BTE hearing device, a CIC hearing device, a RIE hearing device, a RIC hearing device, a MaRIE hearing device or a dome tip/earmold. The vent may be a pressure vent with a small cross section area, which is preferably acoustically sealed. The vent may be an acoustic vent configured for occlusion cancellation. The vent may be an active vent enabling opening or closing of the vent during use of the hearing device. The active vent may comprise a valve.

In an embodiment, the hearing device may comprise a power source. The power source may comprise a battery providing a first voltage. The battery may be a rechargeable battery. The battery may be a replaceable battery. The power source may comprise a power management unit. The power management unit may be configured to convert the first voltage into a second voltage. The power source may comprise a charging coil. The charging coil may be provided by the magnetic antenna.

In an embodiment, the hearing device may comprise a memory, including volatile and non-volatile forms of memory.

In some embodiments, the step of determining the filter values of the hearing device personalized configuration filter comprises determining the filter values of the hearing device personalized configuration filter in time domain or in frequency domain. This in turn allows for compensating, by the hearing device and when the hearing device is in use, for reduced spectral pinna cues of sound signals received by the one or more second acoustic input transducers, compared to the sound signals received by the first acoustic input transducer, based on the determined filter values of the hearing device personalized configuration filter in a flexible manner. This is because the step of determining the filter values may be performed in time domain or in frequency domain i.e. in the flexible manner.

In some embodiments, the step of determining the filter values of the hearing device personalized configuration filter comprises equalizing the behind-the-ear received signal with the in-the-ear received signal in time domain or in frequency domain. Thereby, the step of determining the filter values of the hearing device personalized configuration filter may allow for matching the behind-the-ear received signal with the in-the-ear received signal in time domain or in frequency domain. By the term “equalizing” is hereby meant matching the behind-the-ear received signal with the in-the-ear received signal to make the behind-the-ear received signal similar to the in-the-ear received signal.

In some embodiments, the hearing device further comprises one or more directional filters corresponding to the one or more second acoustic input transducers. The step of determining may further comprise determining filter values of the one or more directional filters in time domain or in frequency domain. Each of the one or more second acoustic input transducers may comprise a corresponding directional filter. The directional filter(s) may be an integer delay. The directional filter(s) does not need to be an integer delay. The step of determining the filter value of the one or more directional filters may allow for creating a desired directional pattern e.g. a pinna restoration pattern or a hypercarioid directional pattern. Thus, the step of determining the filter value of the one or more directional filters may facilitate compensating for reduced pinna cues of sound signals received by the one or more second acoustic input transducers, compared to the sound signals received by the first acoustic input transducer, based on the determined filter values of the hearing device personalized configuration filter. Examples of one or more directional filters are FIR or IIR filters.

In some embodiments, the configuration sound signal is white noise signal or maximum length sequence (MLS) sequence. The configuration sound signal may be a specifically designed sound signal, such as an MLS sequence. The configuration sound signal does not need to be a specifically designed sound signal such as an MLS sequence. The MLS sequence is advantageous in that it allows for personalizing the sound processing of the hearing device in an improved manner e.g. more accurate and user-friendly manner.

In some embodiments, the hearing device comprises one second acoustic input transducer configured to be arranged behind-the-ear, and wherein the behind-the-ear received signal is an omnidirectional signal or a directional signal. The behind-the-ear received signal may be a directional signal in case the one second acoustic input transducer is a directional microphone. Thereby, one second acoustic input transducer may provide an omnidirectional response/pattern or a directional response/pattern.

In some embodiments, the hearing device comprises two second acoustic input transducers configured to be arranged behind-the-ear. The behind-the-ear received signals may be combined to produce a directional signal. Thereby, two second acoustic input transducer may provide directional responses/patterns or may be combined to produce a directional response/pattern that allow for maximizing, or at least improving, the signal-to-noise (SNR) of a compensated output signal to the user's ear and/or to mimic the open ear response.

In some embodiments, the first acoustic input transducer is configured to be arranged in an outer ear of a user of the hearing device, when the hearing device is worn as its intended position. In some embodiments, the first acoustic input transducer is configured to be arranged at an entrance to the ear canal of the user of the hearing device, when the hearing device is worn as its intended position. In some embodiments, the first acoustic input transducer is configured to be arranged inside an ear canal of the user of the hearing device, when the hearing device is worn as its intended position.

In some embodiments, the step of receiving comprises receiving a plurality of configuration sound signals originating from a plurality of directions relative to hearing device. Each of the plurality of directions may be different from one another. In some embodiments, when the step of receiving comprises receiving the plurality of configuration sound signals originating from the plurality of directions relative to the hearing device, the step of providing comprises providing from the first acoustic input transducer a plurality of in-the-ear received signals based on the respective plurality of configuration sound signals and providing from the one or more second acoustic input transducers a plurality of behind-the-ear received signals based on the respective plurality of configuration sound signals.

The plurality of configuration sound signals may originate from a plurality of directions relative to the ear of the user, when the user is wearing the hearing device at its intended position. Preferably, the step of receiving comprises receiving three of configuration sound signals originating from three different directions relative to the hearing device or the ear of the user. Thus, the step of receiving may allow for providing an improved personalizing of the sound processing of the hearing device e.g. more accurate.

In some embodiments, the method further comprises the step of determining an in-the-ear frequency response signal based on the in-the-ear received signal and determining a behind-the-ear frequency response signal based on the behind-the-ear received signal. In some embodiments, when the step of receiving comprises receiving the plurality of configuration sound signals originating from the plurality of directions relative to the hearing device, the step of determining comprises determining a plurality of in-the-ear frequency response signals based on the respective plurality of the in-the-ear received signal and determining a plurality of behind-the-ear frequency response signal based on the respective plurality of behind-the-ear received signal.

The step of determining the in-the-ear frequency response signal based on the in-the-ear received signal and determining the behind-the-ear frequency response signal based on the behind-the-ear received signal may be advantageous when determining the filter values of the hearing device personalized configuration filter in frequency domain. The step of determining the in-the-ear frequency response signal based on the in-the-ear received signal and determining the behind-the-ear frequency response signal based on the behind-the-ear received signal may be advantageous when determining the filter values of the one or more directional filters in frequency domain. Thereby, the step of determining the in-the-ear frequency response signal based on the in-the-ear received signal and determining the behind-the-ear frequency response signal based on the behind-the-ear received signal may facilitate the step of compensating in frequency domain.

In some embodiments, the step of determining filter values of the personalized configuration filter comprises segmenting the in-the-ear frequency response signal and the behind-the-ear frequency response signal into a number of frequency bins. In some embodiments, the step of determining filter values of the personalized configuration filter comprises averaging differences between magnitude response of the in-the-ear frequency response signal and magnitude response of the behind-the-ear frequency response signal over the direction per frequency bin. In some embodiments, the step of determining filter values of the personalized configuration filter comprises averaging differences between phase responses of the in-the-ear frequency response signal and phase responses of the behind-the-ear frequency response signal over the direction per frequency bin. Thereby, the step of determining the filter values of the hearing device personalized configuration filter in frequency domain may equalize both the magnitude and the phase of the behind-the-ear frequency response signal with the respective magnitude and phase of the in-the-ear frequency response signal.

In some embodiments, the step of determining filter values of the personalized configuration filter comprises segmenting the plurality of in-the-ear frequency response signals and the plurality of behind-the-ear frequency response signals into a number of frequency bins. In some embodiments, the step of determining filter values of the personalized configuration filter comprises averaging differences between magnitude responses of the plurality of in-the-ear frequency response signals and magnitude responses of the plurality of behind-the-ear frequency response signals over the plurality of directions per frequency bin. In some embodiments, the step of determining filter values of the personalized configuration filter comprises averaging differences between phase responses of the plurality of in-the-ear frequency response signals and phase responses of the plurality of behind-the-ear frequency response signals over the plurality of directions per frequency bin. The averaging differences between magnitude responses and the averaging differences between phase responses may be weighted depending on the properties e.g. direction of the plurality of received configuration sound signals. The averaging may be a pure average that may equally weigh the received signals. The averaging does not need to be a pure average. For instance, the averaging may weigh the signal from the look direction more than other directions. By the look direction is hereby meant a direction of the user's look. Thereby, the step of determining the filter values of the hearing device personalized configuration filter in frequency domain may equalize both the magnitude and the phase of the plurality of behind-the-ear frequency response signals with the respective magnitude and phase of the plurality of in-the-ear frequency response signals.

In some embodiments, the hearing device further comprises a first wireless communication interface and a first signal processor. In some embodiments, the system further comprises an external device. In some embodiments, the external device may comprise a second wireless communication interface and a second signal processor. In some embodiments, the hearing device and the external device are configured to communicate wirelessly with each other. In some embodiments, the step of determining the filter values of the personalized configuration filter is performed in/at/by the first signal processor of the hearing device or in/at/by the second signal processor of the external device.

The first wireless communication interface of the hearing device may comprise a first antenna and a first wireless communication unit. The second wireless communication interface of the external device may comprise a second antenna and a second wireless communication unit. The hearing device and the external device may be configured to communicate wirelessly with each other e.g. sending and/or receiving signals/information from each other.

Thereby, the step of determining the filter values of the personalized configuration filter may be performed in/at/by the first signal processor of the hearing device. Alternatively or in combination, the step of determining the filter values of the personalized configuration filter may be performed in/at/by the second signal processor of the external device. Thus, the step of determining the filter values of the personalized configuration filter may be performed in a flexible manner using the desired device. In the case that the step of determining the filter values of the personalized configuration filter is performed in/at/by the first signal processor of the hearing device, the external device does not need to comprise a second wireless communication interface and a second signal processor. In the case that the step of determining the filter values of the personalized configuration filter is performed in/at/by the second signal processor of the external device, the filter values may be transmitted to the hearing device to be stored in the hearing device.

In some embodiments, the hearing device further comprises a first memory unit, and the method further comprises storing the filter values of the personalized configuration filter in the first memory unit. The method may comprise storing the filter values of the personalized configuration filter in the first memory unit when step of determining the filter values of the personalized configuration filter is performed in/at/by the first signal processor of the hearing device

In some embodiments, the external device further comprises a second acoustic output transducer. In some embodiments, the external device provides the configuration sound signal.

In some embodiments, the external device provides the plurality of the configuration sound signals. Examples of external device are electronic devices that may provide the configuration sound signals such as mobile phones and computers. Alternatively, the configuration sound signal may be provided by another setup/device such as a device at the audiology clinic.

In some embodiments, the external device further comprises one or more third acoustic input transducers and one or more cameras. In some embodiments, the external device is configured to determine a sound level of an ambient sound environment/scene. The external device may be configured to determine if the determined sound level is below a predetermined ambient sound threshold. In response to a determination that the determined sound level is below the predetermined ambient sound threshold, the external device may be further configured to transmit an initiation signal to the hearing device. The initiation signal may comprise instructions to the hearing device to be configured to receive the configuration sound signal. In response to the determination that the determined sound level is below the predetermined ambient sound threshold, the configuration sound signal may be provided.

Alternatively or in combination, in some embodiments, the external device is configured to determine a distance to the ear of the user. The external device may be configured to determine if the determined distance is above a predetermined distance threshold. In response to a determination that the distance is within the predetermined distance range, the external device may further be configured to transmit an initiation signal to the hearing device. The initiation signal may comprise instructions to the hearing device to be configured to receive the configuration sound signal. In response to the determination that the distance is within the predetermined distance range, the configuration sound signal may be provided.

Alternatively or in combination, in some embodiments, the external device is configured to determine an azimuthal angle to the ear of the user. The external device may be configured to determine if the determined azimuthal angle is within a predetermined azimuthal angle range. In response to a determination that the azimuthal angle is within the predetermined azimuthal angle range, the external device may be further configured to transmit an initiation signal to the hearing device. The initiation signal may comprise instructions to the hearing device to be configured to receive the configuration sound signal. In response to the determination that the azimuthal angle is within the predetermined azimuthal angle range, the configuration sound signal may be provided.

Alternatively or in combination, in some embodiments, the external device may be configured to determine an elevation angle relative to the ear of the user. The external device may be configured to determine if the determined elevation angle is within a predetermined elevation range. In response to a determination that the elevation angle is within the predetermined elevation angle range, the external device may further be configured to transmit an initiation signal to the hearing device. The initiation signal may comprise instructions to the hearing device to be configured to receive the configuration sound signal. In response to the determination that the elevation angle is within the predetermined elevation angle range, the configuration sound signal may be provided.

The external device may determine any of or any combination of the sound level of the ambient sound environment/scene, the distance to the ear of the user, the azimuthal angle to the ear of the user or the elevation angle relative to the ear of the user. The determination of any of or any combination of the sound level of the ambient sound environment/scene, the distance to the ear of the user, the azimuthal angle to the ear of the user or the elevation angle relative to the ear of the user may be part of a configuration application on the external device. The determination of any of or any combination of the sound level of the ambient sound environment/scene, the distance to the ear of the user, the azimuthal angle to the ear of the user or the elevation angle relative to the ear of the user may be performed once for all the configurations sound signals of the plurality of configuration sound signals. The determination of any of or any combination of the sound level of the ambient sound environment/scene, the distance to the ear of the user, the azimuthal angle to the ear of the user or the elevation angle relative to the ear of the user may be performed for each configuration sound signals of the plurality of configuration sound signals.

The determination of any of or any combination of the sound level of the ambient sound environment/scene, the distance to the ear of the user, the azimuthal angle to the ear of the user or the elevation angle relative to the ear of the user may allow for providing distinct and identifiable configuration sound signals. Thereby, they may allow for personalizing the sound processing of the hearing device for the plurality of the directions, corresponding to the respective configuration sound signals, for each individual user in an even more accurate manner.

In some embodiments, the hearing device may further be configured to transmit the in-the-ear frequency response signal and the behind-the-ear frequency response signal via the first wireless communication interface. In some embodiments, the external device may further be configured to receive the in-the-ear frequency response signal and the behind-the-ear frequency response signal via the second wireless communication interface. In some embodiments, the external device may further be configured to provide a notification to the user after receiving the in-the-ear frequency response signals and the behind-the-ear frequency response signal.

The providing of the notification is advantageous in that it notifies the user. Thus, the user may move the external device, such that another configuration sound signal from a different direction may be provided. Examples of the notification may be a sound, a haptic feedback or a visual notification on a display of the external device.

In some embodiments, the external device may further be configured to extract information from a database. The database may comprise database pinna restoration responses of a plurality of ears. The database may further comprise, for each database pinna restoration response, corresponding database directional filters configured to provide the database pinna restoration response. In some embodiments, the method may further comprise comparing the plurality of in-the-ear frequency response signals with the database pinna restoration responses. In some embodiments, the method may further comprise selecting the database pinna restoration response that closest resembles the in-the-ear frequency response signals. In some embodiments, transmitting the corresponding database directional filters to the hearing device.

The transmitting the corresponding database directional filters to the hearing device may be performed via the second and the first wireless communication interfaces.

In some embodiments, the database directional filters are stored in the memory unit of the hearing device. In some embodiments, the plurality of behind-the-ear frequency response signals are directional pinna restoration frequency responses provided using the database directional filters. Thereby, the fine-tuning may be performed within a shorter time either by the user or by the audiologist.

According to a second aspect, a hearing device is disclosed. The hearing device is configured to be worn by a user. The hearing device comprises a first acoustic input transducer configured to be arranged in-the-ear. The hearing device further comprises one or more second acoustic input transducers configured to be arranged behind-the-ear. The hearing device further comprises a hearing device personalized configuration filter, and a first signal processor. The first acoustic input transducer and the one or more second acoustic input transducers are configured to receive a configuration sound signal. The configuration sound signal originates from a direction relative to the hearing device. The first acoustic input transducer is configured to provide an in-the-ear received signal based on the configuration sound signal. The one or more second acoustic input transducers is/are configured to provide a behind-the-ear received signal based on the configuration signal. The first signal processor is configured to determine filter values of the hearing device personalized configuration filter based on the in-the-ear received signal and the behind-the-ear received signal. The hearing device, when in use, is configured to compensate for reduced spectral pinna cues of sound signals received by the one or more second acoustic input transducers, compared to the sound signals received by the first acoustic input transducer, based on the determined filter values of the hearing device personalized configuration filter, thereby providing personalized sound processing of the hearing device.

The second aspect generally presents the same or similar advantages, as defined above in relation to first aspect.

The personalised configuration filter may be configured to equalize the behind-the-ear received signal with the in-the-ear received signal in time domain or frequency domain. The personalised configuration filter may be a personalised equalization filter. The hearing device may further comprise an analog-to-digital converter and a signal processing unit arranged in connection with each of the first acoustic input transducer and/or one or more second acoustic input transducers. In the case that the hearing device comprises more than one second acoustic input transducers, the hearing device may comprise a first summer to add/sum up the behind-the-ear received signal or add/sum up the behind-the-ear frequency response signals. The hearing device may further comprise a filter and a second summer. The filter may be configured to match the in-the-ear received signal or the in-the-ear frequency response signal with the sum of behind-the-ear received signals or the sum of behind-the-ear frequency response signals, as there may be a time delay between them. Examples of such filter are synchronization filter such as a delay filter. The second summer may be configured to add/sum up the in-the-ear received signal or the in-the-ear frequency response signal with the sum of behind-the-ear received signals or the sum of behind-the-ear frequency response signals to determined filter values of the personalized configuration filter.

In some embodiments, the first signal processor is configured to determine filter values of the hearing device personalized configuration filter based on the in-the-ear received signal and the behind-the-ear received signal in time domain or in frequency domain.

In some embodiments, the hearing device comprises one or more directional filters corresponding to the one or more second acoustic input transducers. In some embodiments, the first signal processor may be configured to determine filter values of one or more directional filters based on the in-the-ear received signal and the behind-the-ear received signal in time domain or in frequency domain.

In some embodiments, the hearing device further comprises a first acoustic output transducer. The first acoustic output transducer may be configured to be arranged in-the-ear. The first acoustic output transducer may be configured to emit a compensated output signal to the user's ear, when the hearing device is worn at its intended position and is in use. Thereby, the user may receive the compensated output signal emitted by the first acoustic output transducer.

In some embodiments, the hearing device comprises one second acoustic input transducer. The one second acoustic input transducer may be configured to be arranged behind-the-ear. The behind-the-ear received signal may be an omnidirectional signal or a directional signal.

In some embodiments, the hearing device comprises two second acoustic input transducers. The two second acoustic input transducers may be arranged behind-the-ear. The behind-the-ear received signals may be directional signals.

According to a third aspect, a system is provided. The system comprises an external device and a hearing device. The hearing device is configured to be worn by a user. The system further comprises a signal processor. The signal processor is arranged at the hearing device or at the external device. The external device comprises a second acoustic output transducer and is configured to provide a configuration sound signal. The hearing device comprises a first acoustic input transducer configured to be arranged in-the-ear. The hearing device comprises one or more second acoustic input transducers configured to be arranged behind-the-ear. The hearing device comprises a hearing device personalized configuration filter. The first acoustic input transducer and the one or more second acoustic input transducers are configured to receive a configuration sound signal. The configuration sound signal originates from a direction relative to the hearing device. The first acoustic input transducer is configured to provide an in-the-ear received signal based on the configuration sound signal. The one or more second acoustic input transducers is/are configured to provide a behind-the-ear received signal based on the configuration signal. The signal processor is configured to determine filter values of the hearing device personalized configuration filter based on the in-the-ear received signal and the behind-the-ear received signal. The hearing device, when in use, is configured to compensate for reduced spectral pinna cues of sound signals received by the one or more second acoustic input transducers, compared to the sound signals received by the first acoustic input transducer, based on the determined filter values of the hearing device personalized configuration filter, thereby providing personalized sound processing of the hearing device.

The third aspect generally presents the same or similar advantages, as defined above in relation to the first and the second aspects.

In some embodiments, the system further comprises a second hearing device, such that the hearing device and the second hearing device forms a bilateral hearing device. Thereby, the user may wear the hearing device at one of her/his ears and the second hearing device at the other ones of her/his ears.

According to a fourth aspect, a computer-readable storage medium is provided. The computer-readable storage medium comprises one or more programs for execution by a first signal processor of a hearing device according to the second aspect or by a signal processor of a system according to the third aspect. The one or more programs comprises instructions which, when executed by first signal processor of a hearing device according to the second aspect or by a signal processor of a system according to the third aspect, cause the hearing device according to the second aspect or the system according to the third aspect to perform the method according to the first aspect.

A computer-readable storage medium may be, for example, a software package or an embedded software. The computer-readable storage medium may be stored locally and/or remotely.

The present disclosure relates to different aspects including the method, hearing device and the system described above and in the following, and corresponding device parts, each yielding one or more of the benefits and advantages described in connection with the first mentioned aspect, and each having one or more embodiments corresponding to the embodiments described in connection with the first, second, third or fourth mentioned aspects and/or disclosed in the appended claims.

### BRIEF DESCRIPTION OF THE DRAWINGS

The above and other features and advantages will become readily apparent to those skilled in the art by the following detailed description of exemplary embodiments thereof with reference to the attached drawings, in which:

FIG. 1 schematically illustrates an exemplary hearing device 10.

FIG. 2 schematically illustrates the exemplary hearing device 10, shown in FIG. 1, worn by a user at its intended position.

FIG. 3 schematically illustrates components of the exemplary hearing device 10, shown in FIGS. 1 and 2.

FIG. 4 schematically illustrates an exemplary system 100.

FIG. 5 schematically illustrates steps of a method 200.

### DETAILED DESCRIPTION

Various embodiments are described hereinafter with reference to the figures. Like reference numerals refer to like elements throughout. Like elements will, thus, not be described in detail with respect to the description of each figure. It should also be noted that the figures are only intended to facilitate the description of the embodiments. They are not intended as an exhaustive description of the claimed invention or as a limitation on the scope of the claimed invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated, or if not so explicitly described.

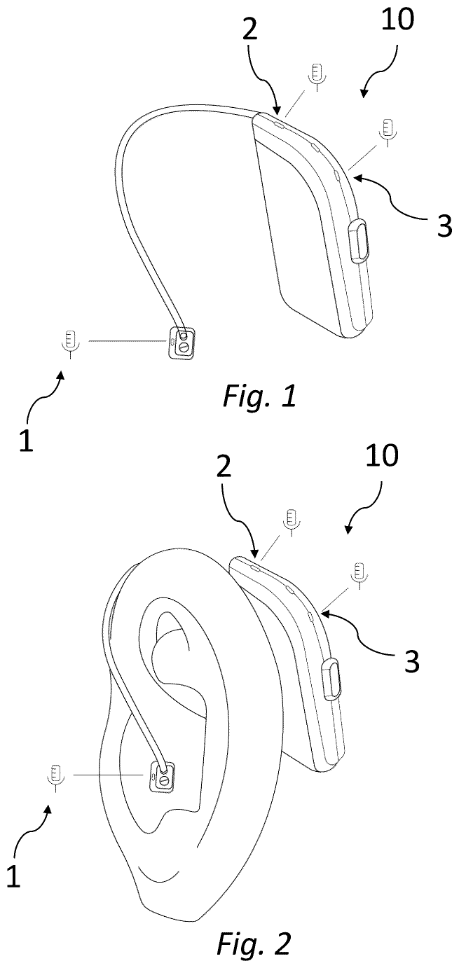

FIGS. 1 and 2 schematically illustrates an exemplary hearing device 10. The hearing device 10 is configured to be worn by a user, as shown in FIG. 2. The hearing device 10 comprises a first acoustic input transducer 1. The first acoustic input transducer 1 is configured to be arranged in-the-ear. FIGS. 1 and 2 show that the first acoustic input transducer 1 is a MIE microphone. The hearing device 10 comprises one or more second acoustic input transducers 2, 3. The one or more second acoustic input transducers 2, 3 is/are configured to be arranged behind-the-ear. The hearing device 10 may comprise one second acoustic input transducer 2. The hearing device 10 may comprise two second acoustic input transducers 2, 3. FIGS. 1 and 2 show that the hearing device 10 comprises two second acoustic input transducers 2, 3. FIGS. 1 and 2 show that the one or more second acoustic input transducers are each a BTE microphone. The hearing device 10 may comprise more than two second acoustic input transducers 2, 3 such as three second acoustic input transducers.

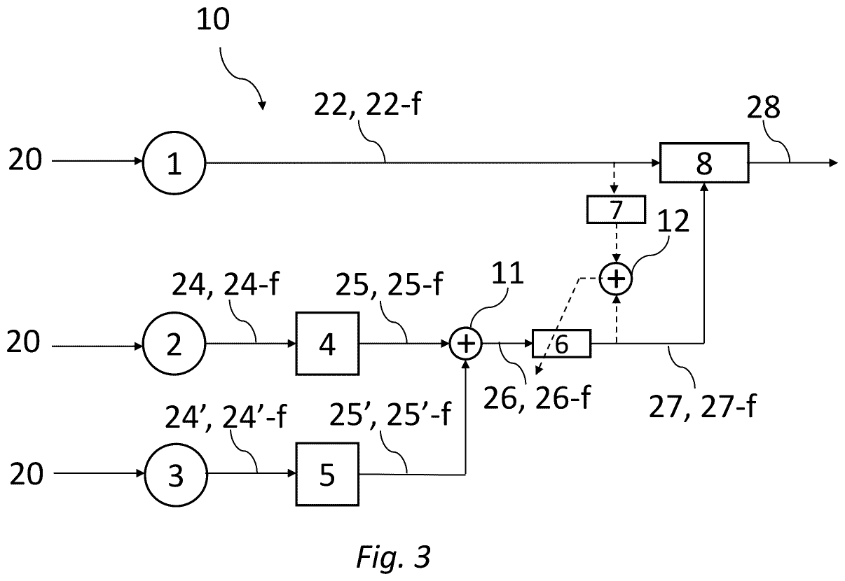

FIG. 3 shows that the hearing device 10 comprises a hearing device personalized configuration filter 6. The hearing device 10 may comprise one or more directional filters 4, 5. The one or more directional filters 4, 5 may correspond to the one or more second acoustic input transducers 2, 3. The hearing device 10 further comprises a first signal processor 8. The first acoustic input transducer 1 and the one or more second acoustic input transducers 2, 3 are configured to receive 210 a configuration sound signal 20. The configuration sound signal 20 originating from a direction D relative to the hearing device when in use. The first acoustic input transducer 1 is configured to provide 220 an in-the-ear received signal 22 based on the configuration sound signal 20. The one or more second acoustic input transducers 2, 3 is configured to provide 220 a behind-the-ear received signal 24, 25, 24′, 25′ based on the configuration signal 20. The first signal processor is configured to determine 240 filter values of the hearing device personalized configuration filter 6 based on the in-the-ear received signal 22 and the behind-the-ear received signal 24, 25, 24′, 25′. The first signal processor may be configured to determine 240 filter values of the hearing device personalized configuration filter 6 in time domain or in frequency domain. The first signal processor 8 may be configured to determine 240 filter values of one or more directional filters 4, 5, based on the in-the-ear received signal 22 and the behind-the-ear received signal 24, 25, 24′, 25′, in the time domain or in the frequency domain.

Still in connection with FIGS. 1, 2, and 3, the hearing device 10, when in use, is configured to compensate 250 for reduced spectral pinna cues of sound signals received by the one or more second acoustic input transducers 2, 3, compared to the sound signals received by the first acoustic input transducer 1, based on the determined filter values of the hearing device personalized configuration filter 6. Thereby, providing personalized sound processing of the hearing device 10.

In the case that the hearing device 10 comprises more than one second acoustic input transducers 2, 3, the hearing device 10 may comprise a first summer 11. The first summer 11 may be configured to add/sum up the behind-the-ear received signal 24, 25, 24′, 25′ and/or add/sum up the behind-the-ear frequency response signals 24-f, 24′-f, 25-f, 25′-f. For instance, when the one or more directional filters 4, 5 are configured to delay signals 24, 24′ or apply a phase shift on 24-f, 24′-f. An output of the first summer 11 may be a directional signal, possibly realizing an average directional pinna response. The directional filters 4 and 5 are usually calibrated to realize an average directional pinna response or e.g. a hyper-cardioid response at the output of the first summer 11. The hearing device may further comprise a filter 7 and a second summer 12. The filter 7 will usually be configured to delay signal 22 or 22-f. The matching the in-the-ear received signal 22 with the sum of behind-the-ear received signals 26 may be performed by delaying the in-the-ear received signal 22 by filter 7 or the matching the in-the-ear frequency response signal 22-f with the sum of behind-the-ear frequency response signals 26-f may be performed by phase-shifting the in-the-ear frequency response signal 22-f by filter 7. The second summer 12 may be configured to subtract the in-the-ear received signal 22 filtered by the filter 7 with the sum of behind-the-ear received signals 26 filtered by the personalized configuration filter 6 to determine the filter values of the personalized configuration filter 6 to provide a personalized filter signal input to the signal processor 8 which produces the compensated output signal 28 based thereon or the second summer 12 may be configured to subtract the in-the-ear frequency response signal 22-f filtered by the filter 7 with the sum of behind-the-ear frequency response signals 26-f filtered by the personalized configuration filter 6 to determine the filter values of the personalized configuration filter 6 to provide a personalized filter signal input 27 and a personalized filter frequency signal input 27-f to the signal processor 8 which produces the compensated output signal 28 based thereon.

For instance, when we denote the filter 6 by F, the signal 26 or 26-f by x and the signal 22 or 22-f possibly filtered by the filter 7 by y, determining the filter 6 would involve minimizing e.g. w (t,f,θ)*(y(t,f,θ)−F*x(t,f,θ))^2 with respect to the filter F either in the time (t) or frequency (f) domain, possibly weighted by the weighting term w that depends on the direction θ of the received signals, summed over all received signals for a certain amount of time or frequencies. The minimization can either be done off-line or by using adaptive on-line approaches. How to perform such an optimization is known to anyone skilled in the art and well known from basic text books.

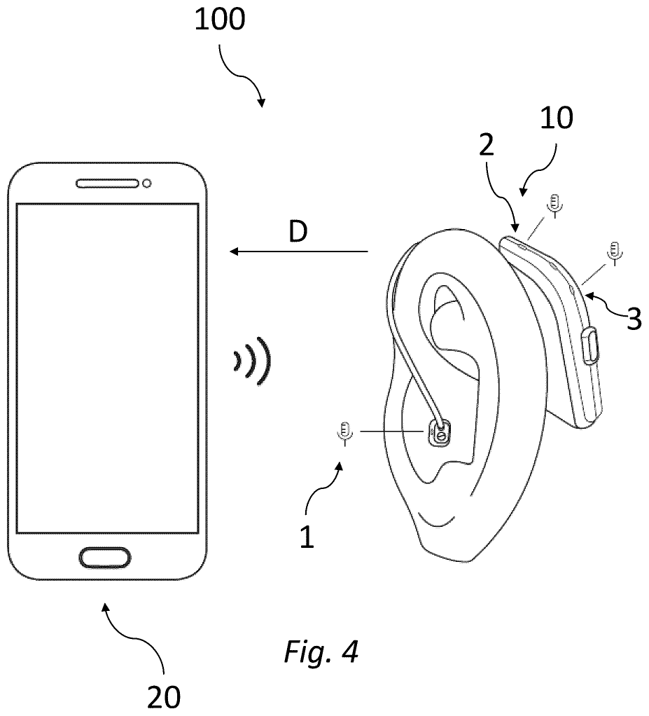

FIG. 4 shows a system 100. The system 100 comprises an external device 20. The external device 20 may be a mobile phone. The system comprises a hearing device 10. The hearing device 10 is configured to be worn by a user. The system 100 comprises a signal processor 8. The signal processor 8 is comprised by the hearing device 10. Alternatively, the signal processor 8 is arranged at the external device 20. The external device 20 comprises a second acoustic output transducer. The second acoustic output transducer of the external device 20 is configured to provide a configuration sound signal. The hearing device 10 comprises a first acoustic input transducer 1. The first acoustic input transducer 1 is configured to be arranged in-the-ear. The hearing device 10 comprises one or more second acoustic input transducers 2, 3. The one or more second acoustic input transducers 2, 3 is/are configured to be arranged behind-the-ear. The hearing device 10 comprises a hearing device personalized configuration filter 6. The first acoustic input transducer 1 and the one or more second acoustic input transducers 2, 3 are configured to receive 210 a configuration sound signal 20. The configuration sound signal 20 originates from a direction D relative to the hearing device 10. The first acoustic input transducer 1 is configured to provide 220 an in-the-ear received signal 22 based on the configuration sound signal 20. The one or more second acoustic input transducers 2, 3 is/are configured to provide 220 a behind-the-ear received signal 24, 25, 24′, 25′ based on the configuration signal 20. The signal processor 8 is configured to determine 240 filter values of the hearing device personalized configuration filter 6 based on the in-the-ear received signal 22 and the behind-the-ear received signal 24, 25, 24′, 25′. The hearing device 10, when in use, is configured to compensate 250 for reduced spectral pinna cues of sound signals received by the one or more second acoustic input transducers 2, 3, compared to the sound signals received by the first acoustic input transducer 1, based on the determined filter values of the hearing device personalized configuration filter 6. Thereby, providing personalized sound processing of the hearing device 10.

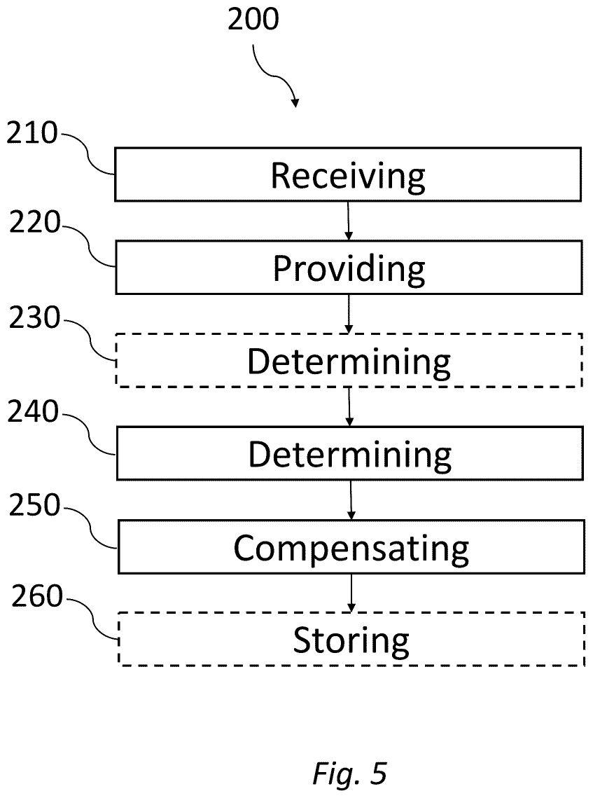

FIG. 5 shows steps of a method 200. The method 200 at a system 100 comprises a hearing device 10. The hearing device 10 is configured to be worn by a user. The hearing device 10 comprises a first acoustic input transducer 1. The first acoustic input transducer 1 is configured to be arranged in-the-ear. The hearing device 10 comprises one or more second acoustic input transducers 2, 3. The one or more second acoustic input transducers 2, 3 is/are configured to be arranged behind-the-ear. The method 200 comprises the step of receiving 210 by the first acoustic input transducer 1 and the one or more second acoustic input transducers 2, 3 a configuration sound signal 20. The configuration sound signal 20 originates from a direction D relative to the hearing device 10. The method 200 comprises the step of providing 220 from the first acoustic input transducer 1 an in-the-ear received signal 22 based on the configuration sound signal 20. The method 200 comprises the step of providing 220 from the one or more second acoustic input transducers 2, 3 a behind-the-ear received signal 24, 25, 24′, 25′ based on the configuration signal 20. The method 200 comprises the step of determining 240 filter values of a hearing device personalized configuration filter 6 based on the in-the-ear received signal 22 and the behind-the-ear received signal 24, 25, 24′, 25′. The method 200 comprises the step of compensating 250, by the hearing device 10 and when in use, for reduced spectral pinna cues of sound signals received by the one or more second acoustic input transducers 2, 3, compared to the sound signals received by the first acoustic input transducer 1, based on the determined filter values of the hearing device personalized configuration filter 6. Thereby, personalizing a sound processing of the hearing device 10.

FIG. 5 shows that the method 200 may further comprise the step of determining 230 an in-the-ear frequency response signal 22-f based on the in-the-ear received signal (22). The method 200 may further comprise the step of determining 230 a behind-the-ear frequency response signal 24-f, 25-f, 24′-f, 25′-f based on the behind-the-ear received signal 24, 25, 24′, 25′. The method 200 may further comprise storing 260 the filter values of the personalized configuration filter 6 in the first memory unit.

A number of embodiments are disclosed by the following list of items:
1. A method (200) at a system (100) comprising a hearing device (10) configured to be worn by a user, the hearing device (10) comprises:
   a first acoustic input transducer (1) configured to be arranged in-the-ear, and
   one or more second acoustic input transducers (2, 3) configured to be arranged behind-the-ear,
the method (200) comprises the steps of:
   receiving (210) by the first acoustic input transducer (1) and the one or more second acoustic input transducers (2, 3) a configuration sound signal (20), the configuration sound signal (20) originating from a direction (D) relative to the hearing device (10),
   providing (220) from the first acoustic input transducer (1) an in-the-ear received signal (22) based on the configuration sound signal (20) and providing (220) from the one or more second acoustic input transducers (2, 3) a behind-the-ear received signal (24, 25, 24′, 25′) based on the configuration signal (20),
   determining (240) filter values of a hearing device personalized configuration filter (6) based on the in-the-ear received signal (22) and the behind-the-ear received signal (24, 25, 24′, 25′), and
   compensating (250), by the hearing device (10) and when in use, for reduced spectral pinna cues of sound signals received by the one or more second acoustic input transducers (2, 3), compared to the sound signals received by the first acoustic input transducer (1), based on the determined filter values of the hearing device personalized configuration filter (6), thereby personalizing a sound processing of the hearing device (10).
2. The method (200) according to item 1, wherein the step of determining (240) the filter values of the hearing device personalized configuration filter (6) comprises equalizing the behind-the-ear received signal (24, 25, 24′, 25′) with the in-the-ear received signal (22) in time domain or in frequency domain.
3. The method (200) according to any one of the preceding items, wherein the hearing device (10) further comprises one or more directional filters (4, 5) corresponding to the one or more second acoustic input transducers (2, 3), wherein the step of determining (240) further comprises determining (240) filter values of the one or more directional filters (4, 5) in time domain or in frequency domain.
4. The method (200) according to any one of the preceding items, wherein the configuration sound signal is white noise signal or maximum length sequence (MLS) sequence.
5. The method (200) according any one of the preceding items, wherein the hearing device (10) comprises one second acoustic input transducer (2) configured to be arranged behind-the-ear, and wherein the behind-the-ear received signal (24) is an omnidirectional signal or a directional signal.
6. The method (200) according to any one of the preceding items, wherein the hearing device comprises two second acoustic input transducers (2, 3) configured to be arranged behind-the-ear, and wherein the behind-the-ear received signals (24, 25, 24′, 25′) are directional signals.
7. The method (200) according to any one of the preceding items, wherein the first acoustic input transducer (1) is configured to be arranged in an outer ear of a user of the hearing device (10), when the hearing device (10) is worn as its intended position.
8. The method (200) according to any one of the items 1-6, wherein the first acoustic input transducer (1) is configured to be arranged at an entrance to the ear canal of the user of the hearing device (10), when the hearing device (10) is worn as its intended position.
9. The method (200) according to any one of the items 1-6, wherein the first acoustic input transducer (1) is configured to be arranged inside an ear canal of the user of the hearing device (10), when the hearing device (10) is worn as its intended position.
10. The method (200) according to any of the preceding items,
   wherein the step of receiving (210) comprises receiving (210) a plurality of configuration sound signals originating from a plurality of directions relative to the hearing device (10), wherein each of the plurality of directions are different from one another, and
      wherein, when the step of receiving (210) comprises receiving (210) the plurality of configuration sound signals originating from the plurality of directions relative to the hearing device (10), the step of providing (220) comprises providing (220) from the first acoustic input transducer (1) a plurality of in-the-ear received signals (22) based on the respective plurality of configuration sound signals and providing (220) from the one or more second acoustic input transducers (2, 3) a plurality of behind-the-ear received signals (24, 25, 24′, 25′) based on the respective plurality of configuration sound signals.
11. The method (200) according to item 10, the method (200) further comprising the step of determining (230) an in-the-ear frequency response signal (22-f) based on the in-the-ear received signal (22) and determining (230) a behind-the-ear frequency response signal (24-f, 25-f, 24′-f, 25′-f) based on the behind-the-ear received signal (24, 25, 24′, 25′) and
   wherein, when the step of receiving (210) comprises receiving (210) the plurality of configuration sound signals originating from the plurality of directions relative to the hearing device (10), the step of determining (230) comprises determining (230) a plurality of in-the-ear frequency response signals (22-f) based on the respective plurality of the in-the-ear received signal (22) and determining (230) a plurality of behind-the-ear frequency response signal (24-f, 25-f, 24′-f, 25′-f) based on the respective plurality of behind-the-ear received signal (24, 25, 24′, 25′).
12. The method (200) according to item 11, wherein the step of determining (240) filter values of the personalized configuration filter comprises:
   segmenting the plurality of in-the-ear frequency response signals (22-f) and the plurality of behind-the-ear frequency response signals (24-f, 25-f, 24′-f, 25′-f) into a number of frequency bins,
   averaging differences between magnitude responses of the plurality of in-the-ear frequency response signals and magnitude responses of the plurality of behind-the-ear frequency response signals over the plurality of directions per frequency bin, and
   averaging differences between phase responses of the plurality of in-the-ear frequency response signals and phase responses of the plurality of behind-the-ear frequency response signals over the plurality of directions per frequency bin.
13. The method (200) according to any one of the preceding items, wherein the hearing device (10) further comprises a first wireless communication interface and a first signal processor;
   wherein the system further comprises an external device, the external device comprises a second wireless communication interface and a second signal processor,
   wherein the hearing device and the external device are configured to communicate wirelessly with each other, and
   wherein the step of determining (240) the filter values of the personalized configuration filter is performed in/at/by the first signal processor (8) of the hearing device (10) or in/at/by the second signal processor of the external device (20).
14. The method (200) according to any one of the preceding items, wherein the hearing device (10) further comprises a first memory unit, and
   wherein the method (200) further comprises storing (260) the filter values of the personalized configuration filter in the first memory unit.
15. The method (200) according to items 13 or 14, wherein the external device (20) further comprises a second acoustic output transducer and wherein the external device (20) provides the configuration sound signal.
16. The method (200) according to item 15, wherein the external device (20) further comprises one or more third acoustic input transducers and one or more cameras;
wherein the external device (20) is configured to:
   determine a sound level of an ambient sound environment/scene;
   determine if the determined sound level is below a predetermined ambient sound threshold; and/or
   determine a distance to the ear of the user;
   determine if the determined distance is above a predetermined distance threshold; and/or
   determine an azimuthal angle to the ear of the user;
   determine if the determined azimuthal angle is within a predetermined azimuthal angle range; and/or
   determine an elevation angle relative to the ear of the user;
   determine if the determined elevation angle is within a predetermined elevation range; and
wherein, in response to a determination that the determined sound level is below the predetermined ambient sound threshold and/or the distance is within the predetermined distance range and/or the azimuthal angle is within the predetermined azimuthal angle range and/or the elevation angle is within the predetermined elevation angle range, the external device (20) is further configured to transmit an initiation signal to the hearing device (10), the initiation signal comprising instructions to the hearing device (10) to be configured to receive the configuration sound signal, and
wherein, in response to the determination that the determined sound level is below the predetermined ambient sound threshold and/or the distance is within the predetermined distance range and/or the azimuthal angle is within the predetermined azimuthal angle range and/or the elevation angle is within the predetermined elevation angle range, the configuration sound signal is provided.
17. The method (200) according to item 13, wherein the hearing device (10) is further configured to transmit the in-the-ear frequency response signal and the behind-the-ear frequency response signal via the first wireless communication interface,
   wherein the external device is further configured to receive the in-the-ear frequency response signal and the behind-the-ear frequency response signal via the second wireless communication interface, and
   wherein the external device (20) is further configured to provide a notification to the user after receiving the in-the-ear frequency response signals and the behind-the-ear frequency response signal.
18. The method (200) according to any of the items 13-17, wherein the external device (20) is further configured to extract information from a database, the database comprising database pinna restoration responses of a plurality of ears, the database further comprising, for each database pinna restoration response, corresponding database directional filters configured to provide the database pinna restoration response,
wherein the method (200) further comprises:
   comparing the plurality of in-the-ear frequency response signals with the database pinna restoration responses,
   selecting the database pinna restoration response that closest resembles the in-the-ear frequency response signals, and
   transmitting the corresponding database directional filters to the hearing device (10).
19. The method (200) according to any of the items 13-17, wherein the database directional filters are stored in the memory unit of the hearing device (10).
20. The method (200) according to any one of items 17 and 18, wherein the plurality of behind-the-ear frequency response signals are directional pinna restoration frequency responses provided using the database directional filters.
21. A hearing device (10) configured to be worn by a user, the hearing device (10) comprises:
   a first acoustic input transducer (1) configured to be arranged in-the-ear, and
   one or more second acoustic input transducers (2, 3) configured to be arranged behind-the-ear,
   a hearing device personalized configuration filter (6), and
   a first signal processor,
   wherein the first acoustic input transducer (1) and the one or more second acoustic input transducers (2, 3) are configured to receive (210) a configuration sound signal (20), the configuration sound signal (20) originating from a direction (D) relative to the hearing device (10),
   wherein the first acoustic input transducer (1) is configured to provide (220) an in-the-ear received signal (22) based on the configuration sound signal (20) and wherein the one or more second acoustic input transducers (2, 3) is configured to provide (220) a behind-the-ear received signal (24, 25, 24′, 25′) based on the configuration signal (20),
   wherein the first signal processor (8) is configured to determine (240) filter values of the hearing device personalized configuration filter (6) based on the in-the-ear received signal (22) and the behind-the-ear received signal (24, 25, 24′, 25′), and
   wherein the hearing device (10), when in use, is configured to compensate (250) for reduced spectral pinna cues of sound signals received by the one or more second acoustic input transducers (2, 3), compared to the sound signals received by the first acoustic input transducer (1), based on the determined filter values of the hearing device personalized configuration filter (6), thereby providing personalized sound processing of the hearing device (10).
22. The hearing device (10) according to item 21, wherein the hearing device (10) comprises one or more directional filters (4, 5) corresponding to the one or more second acoustic input transducers (2, 3) and wherein the first signal processor (8) is configured to determine (240) filter values of the hearing device personalized configuration filter (6) and filter values of one or more directional filters (4, 5), based on the in-the-ear received signal and the behind-the-ear received signal, in the time domain or in the frequency domain.
23. The hearing device (10) according to item 21 or 22, the hearing device (10) further comprising a first acoustic output transducer configured to be arranged in-the-ear, and configured to emit a compensated output signal to the user's ear, when the hearing device (10) is worn at its intended position and is in use.
24. The hearing device (10) according to any of the items 21 to 23, wherein the hearing device (10) comprises one second acoustic input transducer (2) configured to be arranged behind-the-ear, and wherein the behind-the-ear received signal (24) is an omnidirectional signal or a directional signal.
25. The hearing device (10) according to any of the items 21 to 24, wherein the hearing device (10) comprises two second acoustic input transducers (2, 3) arranged behind-the-ear, and wherein the behind-the-ear received signals (24, 25, 24′, 25′) are directional signals.
26. A system (100) comprising an external device (20) and a hearing device (10) configured to be worn by a user, and a signal processor arranged at the hearing device (10) or at the external device (20),
   wherein the external device (20) comprises a second acoustic output transducer and is configured to provide a configuration sound signal,
   wherein the hearing device (10) comprises:
   a first acoustic input transducer (1) configured to be arranged in-the-ear, and
   one or more second acoustic input transducers (2, 3) configured to be arranged behind-the-ear,
   a hearing device personalized configuration filter (6),
   wherein the first acoustic input transducer (1) and the one or more second acoustic input transducers (2, 3) are configured to receive (210) a configuration sound signal (20), the configuration sound signal (20) originating from a direction (D) relative to the hearing device (10),
   wherein the first acoustic input transducer (1) is configured to provide (220) an in-the-ear received signal (22) based on the configuration sound signal (20) and wherein the one or more second acoustic input transducers (2, 3) is configured to provide (220) a behind-the-ear received signal (24, 25, 24′, 25′) based on the configuration signal (20),
   wherein the signal processor is configured to determine (240) filter values of the hearing device personalized configuration filter (6) based on the in-the-ear received signal (22) and the behind-the-ear received signal (24, 25, 24′, 25′), and
wherein the hearing device (10), when in use, is configured to compensate (250) for reduced spectral pinna cues of sound signals received by the one or more second acoustic input transducers (2, 3), compared to the sound signals received by the first acoustic input transducer (1), based on the determined filter values of the hearing device personalized configuration filter (6), thereby providing personalized sound processing of the hearing device (10).
27. The system (100) according to item 26, the system (100) further comprising a second hearing device (10), such that the hearing device (10) and the second hearing device (10) forms a bilateral hearing device (10).
28. A computer-readable storage medium comprising one or more programs for execution by a first signal processor (8) of a hearing device (10) according to any of the items 21-25 or by a signal processor (8) of a system (100) according to item 26 or 27, wherein the one or more programs comprises instructions which, when executed by first signal processor (8) of a hearing device (10) according to any of the items 21-25 or by a signal processor (8) of a system (100) according to item 26 or 27, cause the hearing device according to any of the items 21-25 or the system (100) according to item 26 or 27 to perform the method (100) according to any of items 1-20.

Although particular features have been shown and described, it will be understood that they are not intended to limit the claimed invention, and it will be made obvious to those skilled in the art that various changes and modifications may be made without departing from the scope of the claimed invention. The specification and drawings are, accordingly to be regarded in an illustrative rather than restrictive sense. The claimed invention is intended to cover all alternatives, modifications and equivalents.

### LIST OF REFERENCES

1 First acoustic input transducer
2, 3 Second acoustic input transducer
4, 5 Directional filters
6 Hearing device personalized configuration filter
7 Filter
8 First signal processor/signal processor
10 Hearing device
11 First summer
12 Second summer
20 External device
22 In-the-ear received signal
22-f In-the-ear frequency response signal
24, 24′ Behind-the-ear received signal corresponding to one of second acoustic input transducer
24-f, 25-f Behind-the-ear frequency response signal corresponding to another one of second acoustic input transducer
26 Sum of behind-the-ear received signals
26-f Sum of behind-the-ear frequency response signals
27 Personalized filter signal input
27-f Personalized filter frequency signal input
28 Compensated output signal
D Direction
100 System
200 Method
210 Receiving
220 Providing
230 Determining
240 Determining
250 Compensating
260 Storing

1. A method performed by a system comprising a hearing device configured to be worn by a user, the hearing device comprising a first acoustic input transducer configured to be arranged in an ear of the user, a second acoustic input transducer configured to be arranged behind the ear of the user, the method comprising:
receiving, by the hearing device, a configuration sound signal, wherein the configuration sound signal originates from a direction relative to the hearing device;
providing, by the first acoustic input transducer, an in-the-ear received signal based on the configuration sound signal;
providing, by the second acoustic input transducers, a behind-the-ear received signal based on the configuration signal;
determining filter values of a hearing device personalized configuration filter based on the in-the-ear received signal and the behind-the-ear received signal; and
compensating for reduced spectral pinna cues of sound signals received by the second acoustic input transducer, compared to sound signals received by the first acoustic input transducer, based on the determined filter values of the hearing device personalized configuration filter.

2. The method according to claim 1, wherein the act of determining the filter values of the hearing device personalized configuration filter comprises equalizing the behind-the-ear received signal with the in-the-ear received signal in time domain or in frequency domain.

3. The method according to claim 1, wherein the hearing device further comprises a directional filter corresponding to the second acoustic input transducer, wherein the act of determining the filter values comprises determining values of the directional filter in time domain or in frequency domain.

4. The method according to claim 1, wherein the configuration sound signal is white noise signal or maximum length sequence.

5. The method according to claim 1, further comprising:
receiving another configuration sound signal originating from another direction relative to the hearing device;
providing, by the first acoustic input transducer, another in-the-ear received signal based on the other configuration sound signal, and
providing, by the second acoustic input transducer, another behind-the-ear received signal based on the other configuration sound signal.

6. The method according to claim 5, further comprising:
determining a plurality of in-the-ear frequency response signals based on the in-the-ear received signal and the other in-the-ear received signal, respectively; and
determining a plurality of behind-the-ear frequency response signals based on the behind-the-ear received signal and the other behind-the-ear received signal, respectively.

7. The method according to claim 6, wherein the act of determining filter values of the personalized configuration filter comprises:
segmenting the plurality of in-the-ear frequency response signals and the plurality of behind-the-ear frequency response signals into a number of frequency bins;
averaging differences between magnitude responses of the plurality of in-the-ear frequency response signals and magnitude responses of the plurality of behind-the-ear frequency response signals per each of the frequency bins, and
averaging differences between phase responses of the plurality of in-the-ear frequency response signals and phase responses of the plurality of behind-the-ear frequency response signals per each of the frequency bins.

8. The method according to claim 1, wherein the hearing device further comprises a first wireless communication interface and a first signal processor;
wherein the system further comprises an external device, the external device comprising a second wireless communication interface and a second signal processor;
wherein the hearing device and the external device are configured to communicate wirelessly with each other; and
wherein the act of determining the filter values of the personalized configuration filter is performed in/at/by the first signal processor of the hearing device or in/at/by the second signal processor of the external device.

9. The method according to claim 1, further comprising:
determining an in-the-ear frequency response signal based on the in-the-ear received signal; and
determining a behind-the-ear frequency response signal based on the behind-the-ear received signal.

10. A hearing device configured to be worn by a user, the hearing device comprising:
a first acoustic input transducer configured to be arranged in an ear of the user; and
a second acoustic input transducer configured to be arranged behind the ear of the user;
a hearing device personalized configuration filter; and
a first signal processor;
wherein the hearing device is configured to receive a configuration sound signal, the configuration sound signal originating from a direction relative to the hearing device;
wherein the first acoustic input transducer is configured to provide an in-the-ear received signal based on the configuration sound signal;
wherein the second acoustic input transducers is configured to provide a behind-the-ear received signal based on the configuration signal;
wherein the first signal processor is configured to determine filter values of the hearing device personalized configuration filter based on the in-the-ear received signal and the behind-the-ear received signal; and
wherein the hearing device is configured to compensate for reduced spectral pinna cues of sound signals received by the second acoustic input transducer, compared to sound signals received by the first acoustic input transducer, based on the determined filter values of the hearing device personalized configuration filter.

11. The hearing device according to claim 10, wherein the hearing device comprises a directional filter corresponding to the second acoustic input transducer, and wherein the first signal processor is configured to determine filter values of the hearing device personalized configuration filter and filter values of the directional filter, based on the in-the-ear received signal and the behind-the-ear received signal, in time domain or in frequency domain.

12. The hearing device according to claim 10, the hearing device further comprising a first acoustic output transducer configured to be arranged in the ear of the user, and configured to emit a compensated output signal.

13. The hearing device according to claim 10, wherein the behind-the-ear received signal is an omnidirectional signal or a directional signal.

14. The hearing device according to claim 10, wherein the hearing device comprises another second acoustic input transducer configured to be arranged behind the ear of the user.

15. A system comprising a hearing device configured to be worn by a user, an external device, and a signal processor at the hearing device or at the external device;
wherein the hearing device comprises a first acoustic input transducer configured to be arranged in an ear of the user, a second acoustic input transducer configured to be arranged behind the ear of the user, and a hearing device personalized configuration filter;
wherein the external device is configured to provide a configuration sound signal;
wherein the hearing device is configured to receive the configuration sound signal, the configuration sound signal originating from a direction relative to the hearing device;
wherein the first acoustic input transducer is configured to provide an in-the-ear received signal based on the configuration sound signal;
wherein the second acoustic input transducer is configured to provide a behind-the-ear received signal based on the configuration signal;
wherein the signal processor is configured to determine filter values of the hearing device personalized configuration filter based on the in-the-ear received signal and the behind-the-ear received signal, and
wherein the hearing device is configured to compensate for reduced spectral pinna cues of sound signals received by the second acoustic input transducer, compared to sound signals received by the first acoustic input transducer, based on the determined filter values of the hearing device personalized configuration filter.

16. The system according to claim 15, the system further comprising an additional hearing device, wherein the hearing device and the additional hearing device forms a bilateral hearing device.

17. The system according to claim 15, wherein the external device is configured to:
determine a sound level of an ambient sound environment;
transmit an initiation signal to the hearing device if the determined sound level is below a predetermined ambient sound threshold, the initiation signal configured to instruct or to cause the hearing device to receive the configuration sound signal.

18. The system according to claim 15, wherein the external device is configured to:
determine a distance to the ear of the user;
transmit an initiation signal to the hearing device if the determined distance is above a predetermined distance threshold, the initiation signal configured to instruct or to cause the hearing device to receive the configuration sound signal.

19. The system according to claim 15, wherein the external device is configured to:
determine an azimuthal angle to the ear of the user;
transmit an initiation signal to the hearing device if the determined azimuthal angle is within a predetermined azimuthal angle range, the initiation signal configured to instruct or to cause the hearing device to receive the configuration sound signal.

20. The system according to claim 15, wherein the external device is configured to:
determine an elevation angle relative to the ear of the user;
transmit an initiation signal to the hearing device if the determined elevation angle is within a predetermined elevation range, the initiation signal configured to instruct or to cause the hearing device to receive the configuration sound signal.
